(19) United States
(12) Patent Application Publication
(10) Pub. No.: US 2006/0168530 A1
(43) Pub. Date: Jul. 27, 2006

(54) Task weaver

(75) Inventors: Michael Muller, Medford, MA (US); Andrew L. Schirmer, Andover, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/040,270

(22) Filed: Jan. 21, 2005

(51) Int. Cl. G06F 9/00

(52) U.S. Cl. 715/751

(57) ABSTRACT

A method, system and apparatus for providing a unified view of tasks in a collaborative environment. A collaborative system for presenting a unified view of tasks from heterogeneous task management sources can include a task weaver coupled to one or more heterogeneous task management sources, a unified task database, and, a task weaver user interface coupled to the task weaver and configured to render an arrangement of unified task icons representing underlying tasks in the unified task database. Importantly, the task weaver user interface can include an arrangement of different unified task icons indicating whether a prior task represented by one of the unified task icons is prerequisite to a subsequent task represented by another one of the unified task icons.

### BACKGROUND OF THE INVENTION

1. Statement of the Technical Field

The present invention relates to the field of collaborative computing and more particularly to a unified view of tasks from heterogeneous task lists.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modem collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

Central to any collaborative computing environment, a task list can provide a listing of tasks to be completed by one or more collaborators in a collaborative environment. Yet, the task list of modem collaborative computing environments differ little from legacy task lists. Specifically, in its most simplistic form, a task list can include a sequence of to-dos which can be marked complete as each task is completed. For the individual using a basic to-do list, little more can be required to act as an effective time management tool. In a collaborative environment, however, a basic to-do list can be wholly inadequate as the basic to-do list cannot account for the interactions of multiple collaborators and the dependencies of one task upon the other.

In a collaborative environment, it can be important to view a complete landscape of to-dos or tasks assigned to a team of collaborators. The landscape should indicate a current state of a project based upon the progress of each collaborator in completing the tasks in a task list. To provide a landscape view, however, presupposes the use of a single, harmonized task management system.

Yet, in the modern, distributed computing environment, oftentimes different collaborators can utilize different task management systems. Accordingly, harmonizing the state of different tasks for different collaborators can require a tedious, manual assembly of disparate data. Moreover, the advantages of a collaborative environment, including an awareness of the activities of collaborators and access control to task data for different collaborators can be wholly lacking in a conventional task list.

### SUMMARY OF THE INVENTION

The present invention addresses the deficiencies of the art in respect to task list management and provides a novel and non-obvious method, system and apparatus for providing a unified view of tasks in a collaborative environment. A collaborative system for presenting a unified view of tasks from heterogeneous task management sources can include a task weaver coupled to one or more heterogeneous task management sources, a unified task database, and, a task weaver user interface coupled to the task weaver and configured to render an arrangement of unified task icons representing underlying tasks in the unified task database. Importantly, the task weaver user interface can include an arrangement of different unified task icons indicating whether a prior task represented by one of the unified task icons is prerequisite to a subsequent task represented by another one of the unified task icons.

The unified task database can include one or more tasks and a characterization for each of the tasks. The characterization can include an owner, a priority, and a current state. The characterization further can include a timeliness indication for completing the task, and a set of awareness permissions indicating whether or not the tasks can be viewed by specified collaborators. The characterization yet further can include an established notification for changes to an associated task. Finally, the characterization can include both an input dependency indication for a prior task, and an output dependent indication for a subsequent task.

A task weaver user interface can include an arrangement of different unified task icons. Selected ones of the different unified task icons can indicate whether a prior task represented by one of the unified task icons is prerequisite to a subsequent task represented by another one of the unified task icons. Moreover, a selected one of the different unified task icons can include a visual indicia indicating a status for an underlying task represented by the selected one of the different unified task icons, a timeliness for completing the underlying task, and a priority for the underlying task represented by the selected one of the different unified task icons.

A selected one of the different unified task icons also can provide a visual indicia indicating an owner of an underlying task represented by the selected one of the different unified task icons, a collaborator assigned to complete an underlying task represented by the selected one of the different unified task icons, an established notification for changes to an underlying task represented by the selected one of the different unified task icons or viewing permissions for an underlying task represented by the selected one of the different unified task icons.

Significantly, a selected one of the different unified task icons can include a visual indicia indicating whether an underlying task is blocked, whether the underlying task is associated with a prior task, whether the underlying task has a prerequisite task, or whether completion of a prior task acts to block completion of the underlying task. A selected one of the different unified task icons also can include a visual indicia indicating whether the underlying task precedes another task in a task hierarchy or a task sequence.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a task weaver configured to provide a unified view of tasks originating from heterogeneous task lists;

FIG. 2 is a pictorial illustration of a task icon utilized in the task weaver of FIG. 1; and,

FIG. 3 is a screen shot of a task weaver utilizing the task icon of FIG. 2 to provide a unified view of tasks originating from heterogeneous task lists.

### DETAILED DESCRIPTION OF THE PREFERRED EMBODIMENTS

The present invention is a method, system and apparatus for providing a unified view of tasks in a collaborative environment. In accordance with the present invention, tasks from different, heterogeneous task list management systems can be aggregated into a unified task list for a set of collaborators in the collaborative environment. Each task can be characterized by an owner, a status, a priority, and a linkage basis to other tasks. Each task can be further characterized by access permission data. In any event, the characterization of each task can be visually represented in a unified icon. Consequently, a set of tasks in the unified task list can be represented visually by an arrangement of the unified icons such that interdependent tasks can be represented as a hierarchy of directionally linked unified icons.

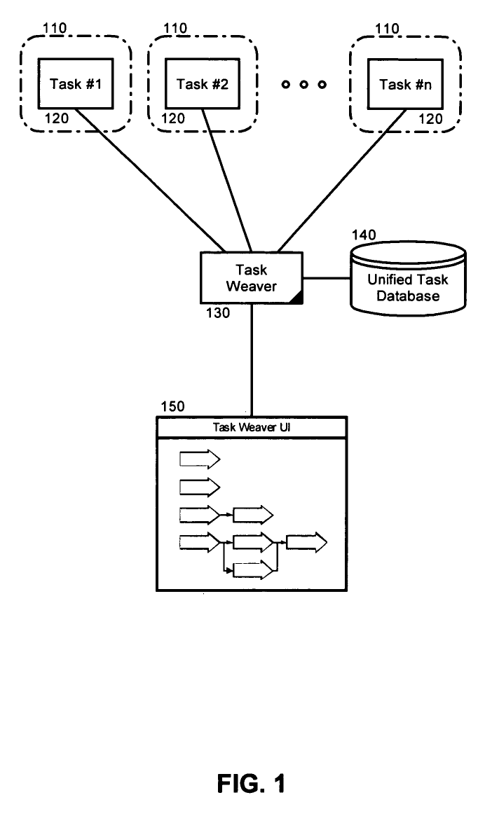

In further illustration, FIG. 1 is a schematic illustration of a task weaver configured to provide a unified view of tasks originating from heterogeneous task lists. As shown in FIG. 1, a multiplicity of tasks 120 can be disposed in different task management systems 110. The task weaver 130 can be coupled to each of the different task management systems 110 so as to aggregate the tasks 120 into a unified task database 140.

Each of the tasks 120 can be characterized according to an owner and a client. Each of the tasks 120 further can be characterized according to a priority and a current state. Each of the tasks 120 yet further can be characterized by a set of permissions indicating whether or not the tasks 120 can be viewed by specified collaborators. Finally, each of the tasks 120 can be characterized by a position in a hierarchy of tasks. For example, the position can include an indication of whether the task is prerequisite to the completion of a subsequent task, or prerequisite to the blocking of the completion of a subsequent task.

Based upon the set of characterizations, a unified visual icon can be produced for each of the tasks 120 in the unified task database 140 so that all of the characterizations can be viewed at glance in the unified icon. Importantly, a set of unified icons representing the tasks 120 in the unified task database 140 can be arranged in a user interface 150 to the task weaver 130. To the extent that different ones of the tasks 120 are dependent upon others of the tasks 120, a hierarchical view of the unified icons can be provided to represent the dependencies of the dependent ones of the tasks 120.

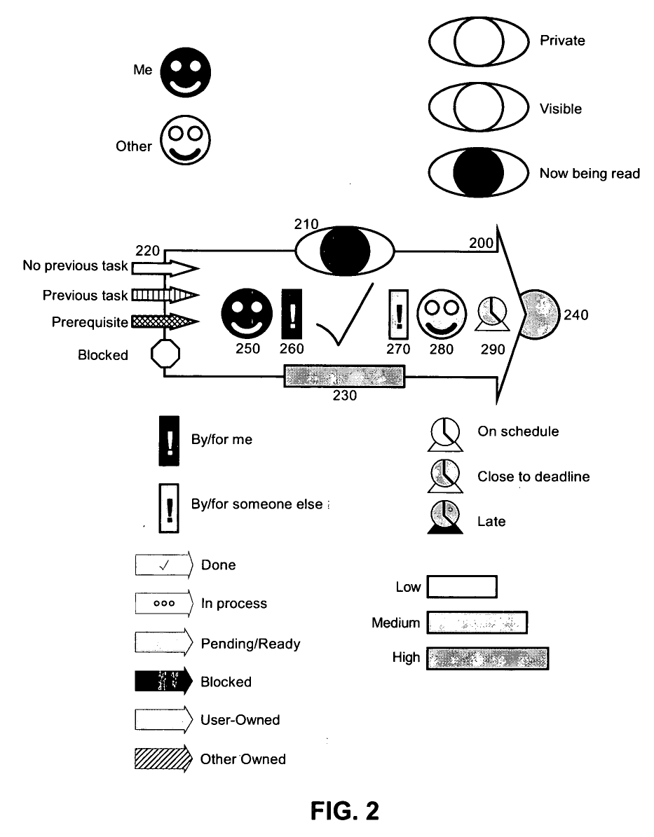

In more particular illustration, FIG. 2 is a pictorial illustration of a unified task icon 200 utilized by the task weaver of FIG. 1. The unified task icon 200 can include a general fill pattern and color indicative of the owner of the task associated with the unified task icon 200. For instance, when the task is owned by the user, the unified task icon 200 can include a solid fill color. By comparison, when the task is owned by a different collaborator, the unified task icon 200 can include a fill pattern. Importantly, the unified task icon 200 can include visual indicia to indicate the status of the task. A solid fill color can indicate that the task is pending or ready, while ellipses disposed within the unified task icon 200 can indicate that the task is in progress. An octagonal image disposed within the unified task icon 200 can indicate that the task has been blocked, perhaps by an incomplete precedent task. Finally, a checkmark disposed within the unified task icon 200 can indicate that the task has been completed.

The unified task icon 200 further can include a visual indicia of awareness 210 for the task. The awareness, for example, can range from private viewing only, to visible to other collaborators, to currently being read. Notably, the task represented by the unified task icon 200 can be incorporated as part of a sequence or hierarchy of independent, or interdependent tasks. To that end, input ports 220 can be provided as can an output port 240.

The input ports 220 can indicate by way of a visual appearance the influence of an antecedent task upon the completion of task represented by the unified task icon 200. For example, the input ports 220 can indicate whether the task requires the completion of an antecedent task, whether the task is associated with an antecedent task, but does not require the completion of a linked antecedent task, or whether the completion of an antecedent task can act to block the completion of the task represented by the unified task icon 200. Similarly, the output port 240 can indicate whether the task is to be linked to a downstream task in a hierarchy or sequence. For instance, a solid fill color for the output port 240 can indicate that the task has been linked, while a transparent fill color can indicate that the task is not linked to another downstream task.

A visual indicia of priority 230 also can be provided. For instance, the priority can range from low to medium to high. A visual indicia of assignment 250 yet further can be included in the unified task icon 200 as can a visual indicia of a client 280. In both cases, the icons utilized for both the visual indicia of assignment 250 and the visual indicia of a client 280 can indicate the user or another collaborator. Similarly, notifications can be established both for the user and the identity of the collaborator establishing the notifications and receiving the notifications can be indicated by dual visual indicia 260, 270. Finally, a timeliness indicia 290 can be provided which can indicate a current state of the task such as “on schedule”, “close to deadline” or “late”, to name a few.

In a preferred aspect of the invention, selected ones of the visual indicia of the unified task icon 200 can be activatable. In particular, responsive to the activation of any of the visual indicia, pertinent characterization information can be provided, such as the identity of a collaborator who has changed the status of the task, the time when the priority of the task has changed, when the task is due, how overdue the task has become, and the like. Presence awareness also can be provided, for instance, by indicating whether a collaborator associated with any characterization of the task is online and available.

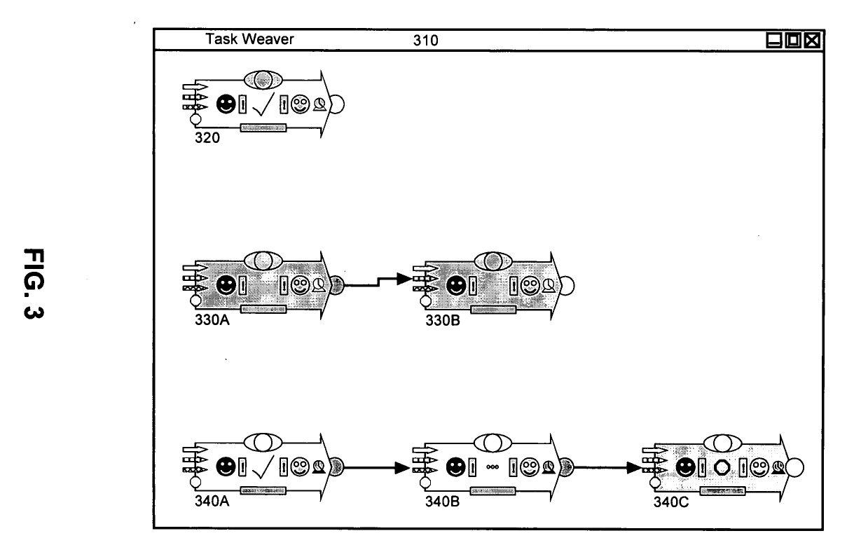

In accordance with the present invention, different ones of the unified task icons 200 can be arranged graphically in a task weaver user interface to produce a visual representation of a collaborative task list for different collaborators in a collaborative environment, irrespective of the source of the different tasks. The visual representation not only can include tasks assigned the viewer, but also the visual representation can include tasks assigned to other collaborators in the collaborative environment. To that end, FIG. 3 is a screen shot of a task weaver utilizing the task icon of FIG. 2 to provide a unified view of tasks originating from heterogeneous task lists.

As shown in FIG. 3, a task weaver user interface 310 can include task icons 320, 330A, 330B, 340A, 340B, 340C representing one or more underlying tasks aggregated from one or more different task management system sources. Considering first the unified task icon 320, a completed task is shown which neither depends upon other tasks, nor forms a dependency for another downstream task. The task is of a high priority, is owned by the viewer and is private to the viewer. The task has been assigned to the viewer and has as a client another collaborator. Finally, the task was completed close to the deadline and notifications were set for the task by another collaborator for the benefit of another collaborator. Importantly, all of the foregoing task characteristics can be apparent from a mere glance of the unified task icon 320.

In a more complex scenario, the unified and interdependent task icons 330A, 330B represent a sequence of pending/ready tasks in which the task represented by the unified task icon 330B is dependent upon the prior unified task icon 330A. Yet, as indicated by the input ports of the unified task icon 330B, the completion of the task represented by the unified task icon 330A is not prerequisite to the completion of the task represented by the unified task icon 330B. In both cases, as shown by the visual indicia of timeliness and awareness, the tasks are on schedule and are private to the viewer.

Finally, considering a yet more complex scenario, the unified task icons 340A, 340B, 340C illustrate a string of interdependent tasks in which each subsequent task is dependent upon the completion of a prior task. In this regard, the task represented by the unified task icon 340A had been completed late, albeit the completion of the task is prerequisite to the completion of the task represented by the unified task icon 340B. The task represented by the unified task icon 340B is in process and is late. Until the task represented by the unified task icon 340B has been completed, the pending task represented by the unified task icon 340C cannot be performed. As such, as shown by the octagon disposed within the unified task icon 340C, the task represented by the unified task icon 340C has been blocked. In all cases, the tasks represented by the unified task icons 340A, 340B, 340C can be viewed by other collaborators.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation: b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A collaborative system for presenting a unified view of tasks from heterogeneous task management sources, the system comprising:
a task weaver coupled to a plurality of heterogeneous task management sources;
a unified task database; and,
a task weaver user interface coupled to said task weaver and configured to render an arrangement of unified task icons representing underlying tasks in said unified task database.

2. The system of claim 1, wherein said unified task database comprises:
a plurality of tasks; and,
a characterization for each of said tasks.

3. The system of claim 2, wherein said characterization comprises an owner, a priority, and a current state.

4. The system of claim 3, wherein said characterization further comprises an awareness indicating whether or not said tasks can be viewed by specified collaborators.

5. The system of claim 3, wherein said characterization further comprises an established notification for changes to an associated task.

6. The system of claim 3, wherein said characterization further comprises a timeliness for completing an associated task.

7. The system of claim 3, wherein said characterization further comprises:
an input dependency indication for a prior task; and,
an output dependent indication for a subsequent task.

8. The system of claim 1, wherein said task weaver user interface comprises an arrangement of different unified task icons indicating whether a prior task represented by one of said unified task icons is prerequisite to a subsequent task represented by another one of said unified task icons.

9. A task weaver user interface comprising an arrangement of different unified task icons.

10. The task weaver user interface of claim 9, wherein selected ones of said different unified task icons indicate whether a prior task represented by one of said unified task icons is prerequisite to a subsequent task represented by another one of said unified task icons.

11. The task weaver user interface of claim 10, wherein a selected one of said different unified task icons comprises a visual indicia indicating a status for an underlying task represented by said selected one of said different unified task icons.

12. The task weaver user interface of claim 10, wherein a selected one of said different unified task icons comprises a visual indicia indicating timeliness for completing an underlying task represented by said selected one of said different unified task icons.

13. The task weaver user interface of claim 10, wherein a selected one of said different unified task icons comprises a visual indicia indicating a priority for an underlying task represented by said selected one of said different unified task icons.

14. The task weaver user interface of claim 10, wherein a selected one of said different unified task icons comprises a visual indicia indicating an owner of an underlying task represented by said selected one of said different unified task icons.

15. The task weaver user interface of claim 10, wherein a selected one of said different unified task icons comprises a visual indicia indicating a collaborator assigned to complete an underlying task represented by said selected one of said different unified task icons.

16. The task weaver user interface of claim 10, wherein a selected one of said different unified task icons comprises a visual indicia indicating an established notification for changes to an underlying task represented by said selected one of said different unified task icons.

17. The task weaver user interface of claim 10, wherein a selected one of said different unified task icons comprises a visual indicia indicating viewing permissions for an underlying task represented by said selected one of said different unified task icons.

18. The task weaver user interface of claim 10, wherein a selected one of said different unified task icons comprises a visual indicia indicating whether an underlying task is blocked, whether said underlying task is associated with a prior task, whether said underlying task has a prerequisite task, or whether completion of a prior task acts to block completion of said underlying task.

19. The task weaver user interface of claim 10, wherein a selected one of said different unified task icons comprises a visual indicia indicating whether said underlying task precedes another task in a task hierarchy or a task sequence.
